(19) United States
(12) Patent Application Publication
(10) Pub. No.: US 2010/0123667 A1
(43) Pub. Date: May 20, 2010

(54) Touch input device, portable device using the same and method of controlling the same

(76) Inventors: Jong Ho Kim, Seo-gu (KR); Yon-Kyu Park, Yuseong-gu (KR); Min Seok Kim, Seo-gu (KR); Dae Im Kang, Yuseong-gu (KR); Jae-Hyuk Choi, Yuseong-gu (KR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/319,958

(22) Filed: Jan. 14, 2009

(30) Foreign Application Priority Data
Nov. 14, 2008 (KR) 10-2008-0113118

(51) Int. Cl. G06F 3/041

(52) U.S. Cl. 345/173

(57) ABSTRACT

Provided are a touch input device capable of acquiring information on whether a pointing object touches a touch panel, information on a touch point of the pointing object touching the touch panel and information on the magnitude of touch force of the pointing object and a method of controlling the same. The touch input device includes a touch panel having a plurality of electrically separated upper electrode strips formed on one side thereof and touched by a pointing object, a first switch electrically connecting the plurality of upper electrode strips to form a single electrode or two electrodes, and an information generator generating at least one of information on a touch point of the pointing object and information on the magnitude of touch force of the pointing object and information on whether the pointing object approaches the touch panel on the basis of a signal received from the touch panel according to a switched state of the first switch.

The application claims the benefit of Korean Patent Application No. 10-2008-0113118, filed Nov. 14, 2008.

### FIELD OF THE INVENTION

The present invention relates to a touch input device and, more particularly, to a touch input device capable of acquiring information on whether a pointing object approaches a touch panel, information on a touch point of the pointing object touching the touch panel and information on the magnitude of touch force of the pointing object, a portable device having the touch input device and a method of controlling the touch input device.

### BACKGROUND OF THE RELATED ART

People are interfaced with electronic/mechanical devices in various applications, and thus they are interested in interfaces that are more natural, easy to use and able to provide information. Among devices interfaced with a user, touch input devices that operate or apply a position command in a touch manner include a touch screen used for a variety of electronic/communication apparatuses such as automated teller machines (ATM), personal digital assistants (PDA) and cellular phones and a touch pad used for notebook computers.

A touch panel used for a conventional touch input device, particularly, a contact resistance touch panel has high brittleness and cannot acquire continuous data signals in proportion to force according to touch of a pointing object (for example, a stylus tip, a finger or the like), and thus the contact resistance touch panel is operated only in an ON/OFF mode. That is, the contact resistance touch panel recognizes only whether touch is applied thereto and detects only a touch point. Furthermore, a capacitance touch panel has a problem that it is difficult to calculate contact resistance. Electronic/communication apparatuses using these touch input devices, particularly, communication devices such as cellular phones in close connection with people cannot sufficiently satisfy increasing demands for acquisition of touch information.

Accordingly, development of a device capable of acquiring not only the position of a pointing object but also information on the magnitude of force according to touch of the pointing object is required.

### SUMMARY OF THE INVENTION

Accordingly, the present invention has been made in view of the above-mentioned problems occurring in the prior art, and it is a primary object of the present invention to provide a touch input device capable of generating information on a touch point of a pointing object, information on touch force of the pointing object and information on whether the pointing object approaches a touch panel, a portable device having the touch input device and a method of controlling the touch input device.

To accomplish the above object of the present invention, according to the present invention, there is provided a touch input device comprising a touch panel having a plurality of electrically separated upper electrode strips formed on one side thereof and touched by a pointing object; a first switch electrically connecting the plurality of upper electrode strips to form a single electrode or two electrodes; and an information generator generating at least one of information on a touch point of the pointing object and information on the magnitude of touch force of the pointing object and information on whether the pointing object approaches the touch panel on the basis of a signal received from the touch panel according to a switched state of the first switch.

Also, the touch panel corresponds to an array type contact resistance touch panel or an array type capacitance touch panel.

In addition, the information generator comprises a position information unit receiving a signal with respect to the touch point of the pointing object from the touch panel to acquire the information on the touch point of the pointing object; a magnitude information unit receiving a signal with respect to the touch force of the pointing object from the touch panel to acquire the information on the magnitude of touch force of the pointing object; and a proximity information unit receiving a signal with respect to a capacitance variation according to proximity of the pointing object from the touch panel to acquire the information on whether the pointing object approaches the touch panel.

Also, the proximity information unit determines whether the pointing object approaches the touch panel based on a proximity threshold value corresponding to a predetermined capacitance variation.

In addition, the magnitude information unit receives a signal with respect to a variation in the capacitance between the upper electrode strips and the pointing object and calculates the magnitude of touch force according to the capacitance or searches for predetermined data to acquire the magnitude of touch force of the pointing object.

Moreover, the information generator selectively activates the position information unit, the magnitude information unit and the proximity information unit.

Also, the first switch is switched based on the information on whether the pointing object approaches the touch panel, acquired by the information generator.

The present invention further comprises a plurality of electrically separated lower electrode strips formed on the other side of the touch panel and a second switch electrically connecting the plurality of lower electrode strips to form a single electrode.

Also, the second switch is switched to form the single electrode when the first switch is switched to form the two electrodes.

In addition, the pointing device corresponds to a part of the human body.

According to another aspect of the present invention, there is provided a mobile apparatus comprising a touch panel having a plurality of electrically separated upper electrode strips formed on one side thereof and touched by a pointing object; a first switch electrically connecting the plurality of upper electrode strips to form a single electrode or two electrodes; an information generator generating at least one of information on a touch point of the pointing object and information on the magnitude of touch force of the pointing object and information on whether the pointing object approaches the touch panel on the basis of a signal received from the touch panel according to a switched state of the first switch; and a display located under the touch panel to provide a screen to a user.

Also, the touch pane of the present invention further comprises a plurality of electrically separated lower electrode strips formed on the other side of the touch panel and a second switch electrically connecting the plurality of lower electrode strips to form a single electrode.

In addition, the display is operated when the information generator generates the information on whether the pointing object approaches the touch panel.

Moreover, according to another aspect of the present invention, there is provided a method of controlling a touch input device, comprising the steps of switching a first switch to electrically connect a plurality of upper electrode strips to form two electrodes; sensing a variation in capacitance between the two electrodes, which is caused by a pointing object; switching the first switch to electrically connect the plurality of upper electrode strips to form a single electrode when the pointing object touches a touch panel; acquiring the magnitude of touch force of the pointing object based on a capacitance variation between the single electrode and the pointing object; switching the first switch such that the plurality of upper electrode strips respectively function as individual electrodes; and acquiring information on the touch point of the pointing object according to the individual electrodes.

In addition, the method of the present invention further comprises the step of switching a second switch to electrically connect a plurality of lower electrode strips to form a single electrode between the step of switching the first switch to form the two electrodes and the step of sensing the capacitance variation, and the step of switching the second switch such that the plurality of lower electrode strips respectively function as individual electrodes between the step of switching the first switch such that the plurality of upper electrode strips respectively function as the individual electrodes and the step of acquiring the information on the touch point of the pointing object.

Moreover, the step of sensing the capacitance variation between the two electrodes is repeated when the pointing object does not touch the touch panel.

In addition, the step of sensing the capacitance variation between the two electrodes determines whether the pointing object approaches the touch panel based on a predetermined proximity threshold value.

Also, the step of sensing the capacitance variation between the two electrodes comprises the step of activating a display of the touch input device when a capacitance variation that exceeds the proximity threshold value is sensed.

In addition, the step of acquiring the information on the magnitude of touch force of the pointing object obtains the magnitude of touch force using at least one of a method of calculating the magnitude of touch force of the pointing object and a method of searching for previously stored magnitude information on the basis of a signal with respect to the capacitance variation between the single electrode and the pointing object.

According to the present invention, it is possible to acquire not only information on the touch point of the pointing object but also information on the magnitude of touch force of the pointing object and information on whether the pointing object approaches the touch panel.

Furthermore, the present invention can provide various interfaces based on the aforementioned characteristics.

Moreover, power consumption of a battery of a portable electronic/communication device using the touch input device can be reduced based on the information on whether the pointing object approaches the touch panel.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a block diagram of a touch input device according to an embodiment of the present invention;

FIG. 2 is a side view of an array type contact resistance touch panel according to an embodiment of the present invention;

FIG. 3 is an exploded perspective view of the array type contact resistance touch panel illustrated in FIG. 2;

FIG. 4 is a side view of an array type capacitance touch panel according to an embodiment of the present invention;

FIG. 5 is an exploded perspective view of the array type capacitance touch panel illustrated in FIG. 3;

FIG. 6 is a conceptional view illustrating that a finger touches a touch panel when upper electrode strips form a single electrode according to the present invention;

FIG. 7a is a conceptional view illustrating that a finger touches a touch panel when upper electrode strips form two electrodes according to the present invention;

FIG. 7b is a conceptional view illustrating that a finger approaches to the touch panel in the state of FIG. 7a; and

FIG. 8 is a flow chart of a method of controlling the touch input device according to an embodiment of the present invention.

### DETAILED DESCRIPTION OF THE PREFERRED EMBODIMENT

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

<Structure of Touch Input Device>

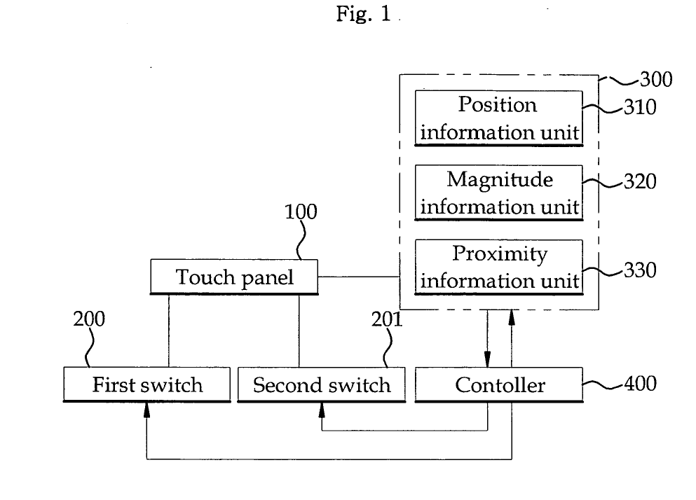

FIG. 1 is a block diagram of a touch input device according to an embodiment of the present invention. Referring to FIG. 1, the touch input device includes a touch panel 100, a first switch 200, an information generator 300 and a controller 400.

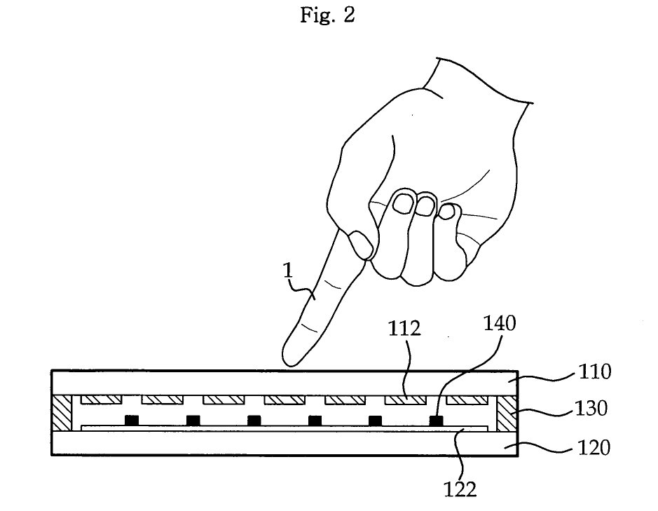

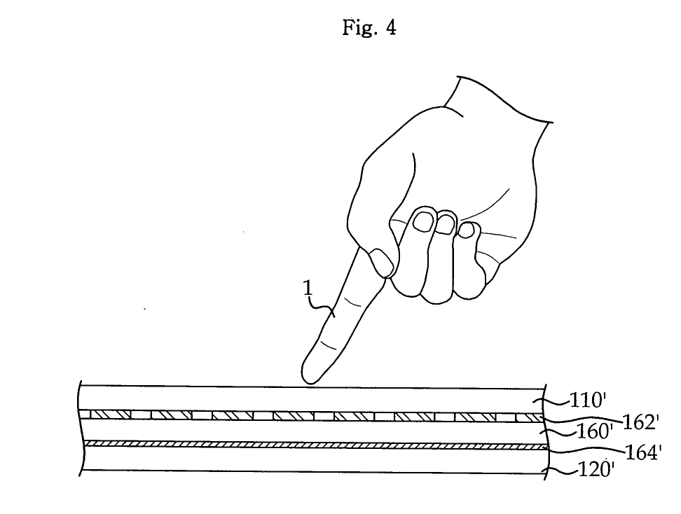

The touch panel 100 is touched by a pointing object 1 and includes a plurality of upper electrode strips 112 or 162′ and a plurality of lower electrode strips 122 or 164′ (refer to FIGS. 2 and 4). The touch input device according to the present invention uses a capacitance variation and the pointing object 1 can be a part of the human body, for example, a finger. The plurality of upper electrode strips 112 or 162′ and the plurality of lower electrode strips 122 or 164′ are electrically separated. The touch panel 100 according to the present invention corresponds to an array type touch panel in which the plurality of upper electrode strips 112 or 162′ are arranged in an array and an array type contact resistance touch panel or an array type capacitance touch panel is used as the touch panel 100. In this array type touch panel, the upper electrode strips arranged in parallel intersect the lower electrode strips arranged in parallel. The touch panel will now be explained in more detail.

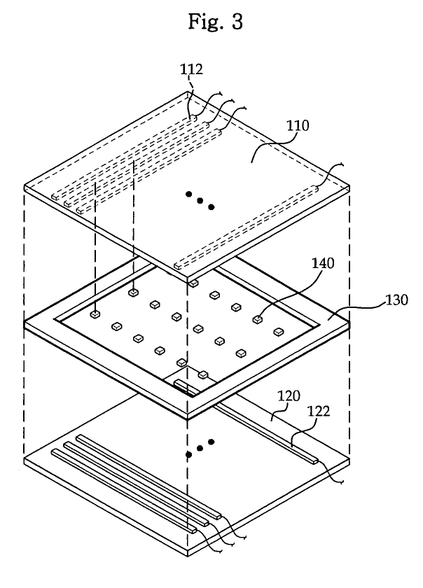

FIG. 2 is a side view of an array type contact resistance touch panel corresponding to the touch panel according to the present invention and FIG. 3 is an exploded perspective view of the array type contact resistance touch panel illustrated in FIG. 2. Referring to FIGS. 2 and 3, the array type contact resistance touch panel includes a top layer 110, the plurality of upper electrode strips 112, a bottom layer 120 and the plurality of lower electrode strips 122. The top layer 110 and the bottom layer 120 are bonded to each other using an adhesive 130 having a predetermined distance therebetween and a spacer 140 is formed between neighboring lower electrode strips 122. The upper electrode strips 112 arranged in parallel intersect the lower electrode strips 122 arranged in parallel. For instance, the upper electrode strips 112 and the lower electrode strips 122 can be formed using a transparent conductive layer such as ITO (Indium Tin Oxide).

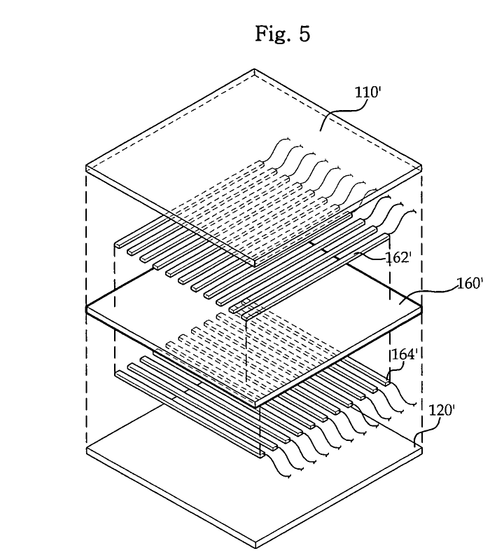

FIG. 4 is a side view of an array type capacitance touch panel corresponding to the touch panel according to an embodiment of the present invention and FIG. 5 is an exploded perspective view of the array type capacitance touch panel illustrated in FIG. 3. Referring to FIGS. 4 and 5, the array type capacitance touch panel includes a top layer 110′, the plurality of upper electrode strips 162′, a middle layer 160′, the plurality of lower electrode strips 164′ and bottom layer 120′. The middle layer 160′ can be formed using an insulator such as glass, plastics or a film. The upper electrode strips 162′ arranged in parallel are formed on the top face of the middle layer 160′ and the lower electrode strips 164′ arranged in parallel are formed on the bottom face of the middle layer 160′. The upper electrode strips 162′ intersect the lower electrode strips 164′.

The plurality of upper electrode strips 112 or 162′ are electrically insulated from the plurality of lower electrode strips 122 or 164′.

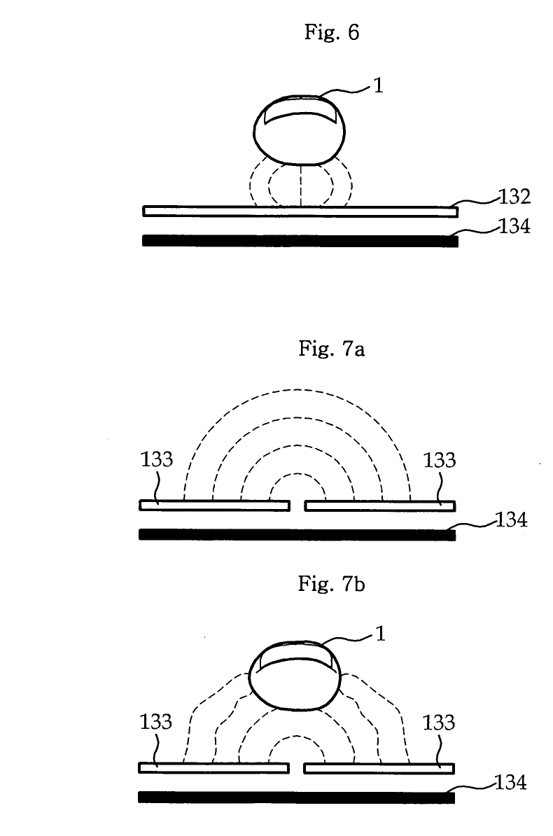

Referring back to FIG. 1, the first switch 200 electrically connects the plurality of electrically separated upper electrode strips 112 or 162′ to form a single electrode 132 or two electrodes 133 (refer to FIGS. 6 and 7). The touch panel further includes a second switch 201 that electrically connects the plurality of electrically separated lower electrode strips 122 or 164′ to form a single electrode 134 (refer to FIGS. 6 and 7). The lower electrode strips 122 or 164′ are electrically connected to form the single electrode 134 according to the second switch 201 when the upper electrode strips 112 or 162′ are electrically connected to form the two electrodes 133 according to the first switch 200. The first switch 200 and the second switch 201 perform the aforementioned operations based on a control signal of the controller 400. Operations of controlling the first switch 200 and the second switch 201, performed by the controller 400, will be explained layer in detail.

FIGS. 6 and 7a illustrate states of the plurality of upper electrode strips 112 or 162′ electrically connected by the first switch 200 and states of the plurality of lower electrodes 122 or 164′ electrically connected by the second switch 201. Referring to FIG. 6, the plurality of upper electrode strips 112 or 162′ form the single electrode 132 according to the first switch 200 and the plurality of lower electrode strips 122 or 164′ form the single electrode 134 according to the second switch 201. Referring to FIG. 7a, the plurality of upper electrode strips 112 or 162′ form the two electrodes 133 according to the first switch 200 and the plurality of lower electrode strips 122 or 164′ form the single electrode 134 according to the second switch 201.

The lower electrode strips 122 and 164′ that form the single electrode 134, illustrated in FIGS. 6, 7a and 7b, reflect capacitance to increase proximity sensitivity.

As illustrated in FIG. 6, when a finger corresponding to a pointing object 1 touches the touch panel while the plurality of upper electrode strips 112 or 162′ form the single electrodes 132 according to the first switch 200, a capacitance variation is induced between the finger 1 and the electrode 132. This capacitance variation increases the contact area of the touch panel and the finger 1 increases.

When the plurality of upper electrode strips 112 or 162′ form the two electrodes 133 according to the first switch 200, as illustrated in FIG. 7a, charges are induced between the two electrodes 133 to generate capacitance. In this case, an electric field formed between the two electrodes 133 is distorted and the capacitance is varied when the finger 1 approaches the two electrodes 133, as illustrated in FIG. 7b.

Referring back to FIG. 1, the information generator 300 generates one of information on a touch point of the pointing object 1 and information on the magnitude of touch force of the pointing object 1 and information on whether the pointing object 1 approaches the touch panel 100 based on a signal received from the touch panel 100 according to a switched state of the first switch 200 or the second switch 201. Preferably, the information generator 300 generates all the three information items. The information generator 300 includes a position information unit 310, a magnitude information unit 320 and a proximity information unit 330.

The position information unit 310 generates the information on the touch point of the pointing object as predetermined coordinates. When the pointing object 1 touches the touch panel 100 including the plurality of electrically separated upper electrode strips 112 or 162′, an electric signal with respect to the touch point is generated. The position information unit 310 receives the electric signal and represents the touch point of the pointing object I on a coordinate system (for example, an x-y coordinate system).

The magnitude information unit 320 acquires the information on the magnitude of touch force of the pointing object 1. When the upper electrode strips 112 or 162′ form the single electrode 132 according to the first switch 200 and the pointing object 1 touches the touch panel 100, a capacitance variation is induced between the pointing object 1 and the electrode 132, as described above. The magnitude information unit 320 generates the information on the magnitude of touch force of the pointing object 1 based on a signal corresponding to the capacitance variation. The magnitude of touch force can be calculated based on a formula that represents the relationship between touch force and a capacitance variation or acquired by searching for previously stored data. Otherwise, the magnitude of touch force can be obtained by using both of these two methods. The previously stored data corresponds to a look-up table with respect to the magnitude of touch force corresponding to a capacitance variation. When the previously stored data is used, a response speed of the magnitude information unit 320 increases.

The proximity information unit 330 generates the information on whether the pointing object 1 approaches the touch panel 100. When the upper electrode strips 112 or 162′ form the two electrodes 133 and the finger corresponding to the pointing object 1 is placed in proximity to the two electrodes 133, a capacitance variation occurs, as described above. This capacitance variation is continuous, and thus it is desirable that a capacitance variation value corresponding to a proximity threshold voltage is set in advance. That is, proximity of the pointing object is recognized when the capacitance variation exceeds the proximity threshold value and the proximity of the pointing object is not recognized when the capacitance variation does not reach the proximity threshold value. For example, a capacitance value when the finger corresponding to the pointing object 1 is placed apart from the touch input device by about 5cm can be set to the proximity threshold value. The aforementioned operation of the proximity information unit 330 can be used to minimize power consumption of an electronic/communication apparatus (not shown) using the touch input device according to the present invention. For example, a display (not shown) of the electronic/communication apparatus is activated only when proximity is recognized to provide a screen to a user so as to reduce power consumption of the electronic/communication apparatus.

The controller 400 controls the first switch 200, the second switch 201 and the information generator 300. When the upper electrode strips 112 or 162′ of the touch input device form the two electrodes 133 and the lower electrode strips 122 or 164′ form the single electrode 134, the information generator 300 determines whether the pointing object 1 approaches the touch panel and generates information on whether the pointing object 1 approaches the touch panel. When the pointing object 1 approaches and touches the touch panel, the controller 400 controls the first switch 200 to electrically connect the upper electrode strips 122 or 162′ to form the single electrode 132 and activates the magnitude information unit 320 of the information generator 300 to acquire the information on the magnitude of touch force of the pointing object 1. While the magnitude information unit 320 acquires the information on the magnitude of touch force of the pointing object, the proximity information unit 330 and the position information unit 310 are not activated, that is, proximity information unit 330 and the position information unit 310 are not operated, and thus power consumption can be minimized. When the information on the magnitude of touch force is acquired, the controller 400 controls the first switch 200 and the second switch 201 to electrically separate the upper electrode strips 112 or 162′ and the lower electrode strips 122 or 162′ such that the upper electrode strips 112 or 162′ and the lower electrode strips 122 or 164′ respectively function as individual electrodes and activates the position information unit 310 of the information generator 300. The controller 400 controls the information generator 300, the first switch 200 and the second switch 201 in the aforementioned manner.

A portable device includes the aforementioned touch input device and a display (not shown) located beneath the touch panel 100 to provide a screen to a user.

<Control Method>

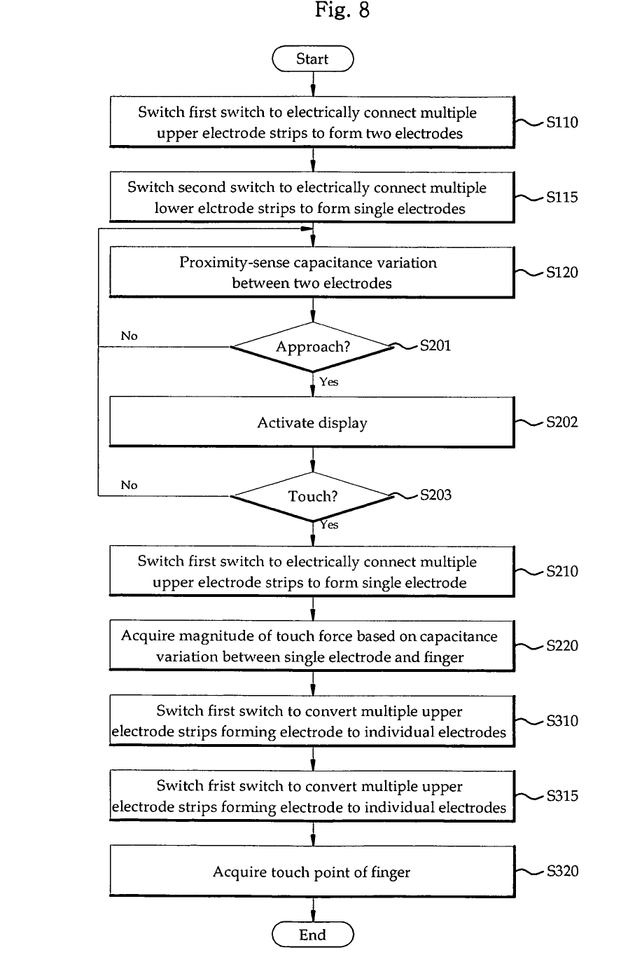

FIG. 8 is a flow chart of a method of controlling the touch input device according to an embodiment of the present invention. The touch input device according to the present invention operates as a proximity sensor before a user touches the touch panel 100 using the pointing object 1 to input an operating command or a position command. That is, the first switch 200 is switched to electrically connect the upper electrode strips 112 or 162′ to form the two electrodes 133 in step S110. The second switch 201 is also switched to electrically connect the lower electrode strips 122 or 164′ to form the single electrode 134 in step S115. A variation in the capacitance between the two electrodes 133, which depends on whether the pointing object 1 approaches the touch panel 100, is sensed to determine whether the pointing object 1 approaches the touch panel 100 in step S120. It is determined whether the pointing object 1 approaches the touch panel 100 according to whether there is a capacitance variation corresponding to a predetermined proximity threshold value, which has been described above.

When it is sensed that the pointing object 1 approaches the touch panel 100 such that the capacitance variation exceeds the proximity threshold value although the pointing object 1 does not touch the touch panel 100, a display of the touch input device is activated to provide a screen to a user so as to minimize power consumption.

When the pointing object 1 touches the touch panel 100, the first switch 200 is switched to electrically connect the plurality of upper electrode strips 112 or 162′ to form the single electrode 132 in step S210. The capacitance between the single electrode 132 and the pointing object 1 is varied. The magnitude information unit 320 of the information generator 300 acquires information on the magnitude of touch force of the pointing object based on the capacitance variation in step S220. The magnitude of touch force of the pointing object can be calculated, acquired by searching for data previously stored in a look-up table or obtained by using both the calculating and searching methods, which has been explained above.

When the pointing object 1 does not touch or approach the touch panel 100, the step S120 is repeated.

When the information on the magnitude of touch force of the pointing object is acquired, the first switch 200 is switched to electrically separate the plurality of upper electrode strips 112 or 162′ operating as the single electrode 132 such that the upper electrode strips 112 or 162′ respectively function as individual electrodes in step S3 10 and the second switch 201 is switched to electrically separate the plurality of lower electrode strips 122 or 164′ operating as the single electrode 134 such that the lower electrode strips 122 or 164′ respectively function as individual electrodes in step S315. Information on the touch point of the pointing object 1 is acquired in the state that the upper electrode strips 112 or 162′ and the lower electrode strips 122 or 164′ are electrically separated and function as individual electrodes in step S320. A method of acquiring the information on the touch point is identical to a conventional method of acquiring position information of a conventional touch panel, that is, a touch screen, so that detailed explanation thereof is omitted.

<Modified Embodiments>

The touch input device according to the present invention can be used for any electronic/communication apparatus that receives an operating command or a position command through a user's finger. Examples of the electronic/communication apparatus include cellular phones, smart phones, PDP, PDA, navigation systems, game players and so on.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A touch input device comprising:
a touch panel having a plurality of electrically separated upper electrode strips formed on one side thereof and touched by a pointing object;
a first switch electrically connecting the plurality of upper electrode strips to form a single electrode or two electrodes; and
an information generator generating at least one of information on a touch point of the pointing object and information on the magnitude of touch force of the pointing object and information on whether the pointing object approaches the touch panel on the basis of a signal received from the touch panel according to a switched state of the first switch.

2. The touch input device according to claim 1, wherein the touch panel corresponds to an array type contact resistance touch panel or an array type capacitance touch panel.

3. The touch input device according to claim 1, wherein the information generator comprises:
a position information unit receiving a signal with respect to the touch point of the pointing object from the touch panel to acquire the information on the touch point of the pointing object;
a magnitude information unit receiving a signal with respect to the touch force of the pointing object from the touch panel to acquire the information on the magnitude of touch force of the pointing object; and
a proximity information unit receiving a signal with respect to a capacitance variation according to proximity of the pointing object from the touch panel to acquire the information on whether the pointing object approaches the touch panel.

4. The touch input device according to claim 3, wherein the proximity information unit determines whether the pointing object approaches the touch panel based on a proximity threshold value corresponding to a predetermined capacitance variation.

5. The touch input device according to claim 3, wherein the magnitude information unit receives a signal with respect to a variation in the capacitance between the upper electrode strips and the pointing object and calculates the magnitude of touch force according to the capacitance or searches for predetermined data to acquire the magnitude of touch force of the pointing object.

6. The touch input device according to claim 3, wherein the information generator selectively activates the position information unit, the magnitude information unit and the proximity information unit.

7. The touch input device according to claim 1, wherein the first switch is switched based on the information on whether the pointing object approaches the touch panel, acquired by the information generator.

8. The touch input device according to claim 1, further comprising a plurality of electrically separated lower electrode strips formed on the other side of the touch panel and a second switch electrically connecting the plurality of lower electrode strips to form a single electrode.

9. The touch input device according to claim 8, wherein the second switch is switched to form the single electrode when the first switch is switched to form the two electrodes.

10. The touch input device according to claim 1, wherein the pointing device corresponds to a part of the human body.

11. A mobile apparatus comprising:
a touch panel having a plurality of electrically separated upper electrode strips formed on one side thereof and touched by a pointing object;
a first switch electrically connecting the plurality of upper electrode strips to form a single electrode or two electrodes;
an information generator generating at least one of information on a touch point of the pointing object and information on the magnitude of touch force of the pointing object and information on whether the pointing object approaches the touch panel on the basis of a signal received from the touch panel according to a switched state of the first switch; and
a display located under the touch panel to provide a screen to a user.

12. The mobile apparatus according to claim 11, further comprising a plurality of electrically separated lower electrode strips formed on the other side of the touch panel and a second switch electrically connecting the plurality of lower electrode strips to form a single electrode.

13. The mobile apparatus according to claim 11, wherein the display is operated when the information generator generates the information on whether the pointing object approaches the touch panel.

14. A method of controlling a touch input device, comprising the steps of:
switching a first switch to electrically connect a plurality of upper electrode strips to form two electrodes;
sensing a variation in capacitance between the two electrodes, which is caused by a pointing object;
switching the first switch to electrically connect the plurality of upper electrode strips to form a single electrode when the pointing object touches a touch panel;
acquiring the magnitude of touch force of the pointing object based on a capacitance variation between the single electrode and the pointing object;
switching the first switch such that the plurality of upper electrode strips respectively function as individual electrodes; and
acquiring information on the touch point of the pointing object according to the individual electrodes.

15. The method according to claim 14, further comprising the step of switching a second switch to electrically connect a plurality of lower electrode strips to form a single electrode between the step of switching the first switch to form the two electrodes and the step of sensing the capacitance variation, and the step of switching the second switch such that the plurality of lower electrode strips respectively function as individual electrodes between the step of switching the first switch such that the plurality of upper electrode strips respectively function as the individual electrodes and the step of acquiring the information on the touch point of the pointing object.

16. The method according to claim 14, wherein the step of sensing the capacitance variation between the two electrodes is repeated when the pointing object does not touch the touch panel.

17. The method according to claim 14, wherein the step of sensing the capacitance variation between the two electrodes determines whether the pointing object approaches the touch panel based on a predetermined proximity threshold value.

18. The method according to claim 14, wherein the step of sensing the capacitance variation between the two electrodes comprises the step of activating a display of the touch input device when a capacitance variation that exceeds the proximity threshold value is sensed.

19. The method according to claim 14, wherein the step of acquiring the information on the magnitude of touch force of the pointing object obtains the magnitude of touch force using at least one of a method of calculating the magnitude of touch force of the pointing object and a method of searching for previously stored magnitude information on the basis of a signal with respect to the capacitance variation between the single electrode and the pointing object.
